(19) United States
(12) Patent Application Publication
(10) Pub. No.: US 2009/0238981 A1
(43) Pub. Date: Sep. 24, 2009

(54) Powder coating composition for metal deposition

(76) Inventors: Owen H. Decker, Idaho Falls, ID (US); Thomas E. Jeffes, Houston, TX (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/381,848

(22) Filed: Mar. 17, 2009

Related U.S. Application Data
(60) Provisional application No. 61/069,863, filed on Mar. 18, 2008.

(51) Int. Cl. C08L 67/07; C08L 71/00; B05D 3/10

(52) U.S. Cl. 427/386; 524/611; 524/599

(57) ABSTRACT

A powder coating composition for coating substrates providing enhanced smoothness of the coatings suitable for vapor metal deposition, the composition comprising an intimate mixture comprising
A) 50 to 99 wt % of at least one resin binder selected from the group consisting of polyester resins, epoxy resins, urethane resins, (meth)acrylic resins, silicone resins, fluorocarbon resins, phenolic resins
B) 0 to 95 wt % of at least one cross-linking agent,
C) 0.1 to 10 wt % of at least one opacifying agent, and
D) 0.01 to 20 wt % of at least one coating additive, pigment and/or extender (filler), the wt % are based on the total weight of the powder coating composition; wherein the powder coating composition on curing forms a surface having excellent smoothness suitable for vapor metal deposition and provides a DOI smoothness measurement by an easy and an exacting working procedure.

### CROSS REFERENCE TO RELATED APPLICATIONS

This application claims the benefit of U.S. Provisional Application Ser. No. 61/069,863 filed on Mar. 18, 2008 which is hereby incorporated by reference.

### FIELD OF THE INVENTION

The invention is directed to a powder coating composition for coating substrates providing enhanced smoothness of the coatings, suitable for vapor metal deposition.

### DESCRIPTION OF RELATED ART

Precious metal thin films play a role in a variety of industrial fields, particularly in electronic devices. Methods for depositing such metal coatings are, for example, vapor metal deposition and chemical vapor metal deposition. The metallization is not restricted to a specific metal; the depositing may comprise the use of metals such as copper, silver, aluminium, gold, titanium, iron, chromium, nickel. U.S. Pat. No. 6,074,740 describes, for example, plastic parts metalized by vapor deposition having improved adhesion of the metal coat to plastic substrates.

It is well-known to use powder coating compositions as primers coated directly on the substrate surface. Substrates need to have a smooth and homogenous surface if further coating layers are to be applied on the surface. Primer coating compositions can be used to seal the surface of such substrates and to provide the required surface quality for the application of a further coating layer. Commonly, the smoothness of the surface provided by current primer coating compositions is not suitable for vapour metal deposition. In general, materials used as substrates for vapor metal deposition must provide a surface that is extremely smooth. This is true because the smoothness of the substrate directly determines the smoothness and mirror qualities of the applied metal layer.

Assessing smoothness and observing defects in thin coating films over metal substrates can be difficult. To ease the task of making smooth surfaces, these primer coatings are traditionally clear, unpigmented and unfilled. But since these coatings are clear, minute defects which would render them unsuitable for subsequent metallization are difficult to detect.

Various methods may be used to assess the smoothness of coatings. Two common, inexpensive methods are the visual smoothness determination and the machine optical Distinctness of Image (DOI) smoothness measurement.

Visual smoothness determination depends on worker eyesight, training and experience, and therefore this method can be unreliable. A defect is typically only discovered after the coating product has been bought, shipped, applied to parts and metalized, and this results in wasted time and additional costs.

DOI smoothness is typically measured on a scale from 0 to 100. A standard procedure for making DOI measurements is described in ASTM standard D 5657-95, reapproved 1999. When an image is reflected clearly and without distortion, its DOI value approaches 100. To be useful as substrate surface for vapor metalization, the substrate surface must present a DOI of at least 95. A DOI evaluation depends on the capacity of the wavescan-DOI meter to measure the angular dependence of reflected light. However, since powder coatings used as substrates for vapor metal deposition are typically clear, a portion of the incident light penetrates the coating, and reflects off the substrate. Defects on the substrate may cause light to be reflected at a variety of angles. Measurements of the smoothness of the surface are thereby confounded by simultaneous measurement of the smoothness of the substrate beneath the clear film.

There is a need to provide powder coatings with an excellent smoothness suitable for vapor metal deposition, and, at the same time, providing an easy and exacting DOI smoothness measurement.

### SUMMARY OF THE INVENTION

The present invention provides a powder coating composition for coating substrates providing enhanced smoothness of the coatings suitable for vapor metal deposition, the composition comprises an intimate mixture comprising of the following constituents
A) 50 to 99 wt % of at least one resin binder selected from the group consisting of polyester resins, epoxy resins, urethane resins, (meth)acrylic resins, silicone resins, fluorocarbon resins or phenolic resins
B) 0 to 95 wt % of at least one cross-linking agent,
C) 0.1 to 10 wt % of at least one opacifying agent, and
D) 0.01 to 20 wt % of at least one coating additive, pigment and/or extender (filler),
   wherein the wt % are based on the total weight of the powder coating composition.

The powder coating composition according to the invention cures rapidly and completely and makes it possible to receive coatings with excellent adhesion to the substrate surface as well as with excellent smoothness suitable for vapor metal deposition, and, at the same time, providing a DOI smothness measurement by an easy and exacting working procedure. The powder coating composition according to the invention is therefore particularly suitable as material for vapour metal deposition to provide precious metal thin films. The powder coating layer improves corrosion resistance and provides a smooth surface without the expensive polishing step required to smooth an uncoated metal surface.

### DETAILED DESCRIPTION OF THE INVENTION

The features and advantages of the present invention will be more readily understood, by those of ordinary skill in the art, from reading the following detailed description. It is to be appreciated those certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural unless the context specifically states otherwise.

The use of numerical values in the various ranges specified in this application, unless expressly indicated otherwise, are stated as approximations as though the minimum and maximum values within the stated ranges. In this manner, slight variations above and below the stated ranges can be used to achieve substantially the same results as values within the ranges. Also, the disclosure of these ranges is intended as a continuous range including every value between the minimum and maximum values.

The powder coating composition according to the invention comprising 50 to 99 wt %, preferably 70 to 95 wt %, of at least one of the resin binders A), 0 to 95 wt %, preferably 1 to 50 wt % of cross-linking agent B), 0.1 to 10 wt %, preferably 0.2 to 5 wt % of opacifying agent C), and 0.01 to 20 wt % of at least one coating additive, pigment and/or extender (fillers) of component D).

The wt % named in this description is based on the total weight of the powder coating composition according to the invention.

The thickness named in this description has the meaning of dry film thickness and is determined by the standard method of ASTM D7091-05.

Suitable polyesters are saturated and/or unsaturated polyesters known to a person skilled in the art and which may be produced in a conventional manner by reacting polycarboxylic acids, and the anhydrides and/or esters thereof with polyalcohols, as is, for example, described in D. A. Bates, The Science of Powder Coatings, volumes 1 & 2, Gardiner House, London, 1990.

Examples of suitable polycarboxylic acids, and the anhydrides and/or esters thereof include maleic acid, fumaric acid, malonic acid, adipic acid, 1.4-cyclohexane dicarboxylic acid, isophthalic acid, terephthalic acid, acrylic acid, and their anhydride form, or mixtures thereof. Examples of suitable alcohols are benzyl alcohol, butanediol, hexanediol, diethylene glycol, pentaerytritol, neopentyl glycol, propylene glycol, and mixtures thereof.

Mixtures of carboxyl and hydroxyl group containing unsaturated polyesters may be used. The carboxy-functionalized polyesters according to the invention has an acid value of 10 to 200 mg of KOH/g of resin, and the hydroxy-functionalized polyesters has an OH value of 10 to 200 mg of KOH/g of resin.

Epoxy resins are also usable as component A). Examples of suitable epoxy resins are epoxies, such as, e.g., reaction products prepared from epichlorohydrin with bisphenol, for example bisphenol A; novolac epoxy resins based on phenol or cresol novolac; functionalized resins such as acrylated epoxies, as known at a person skilled in the art.

Suitable (meth)acrylic resins are resins, such as, e.g., copolymers prepared from alkyl methacrylates with glycidyl(meth)acrylates and olefinic monomers; functionalized resins such as polyester acrylics, epoxy acrylics, urethane acrylates.

Suitable urethane resins are, e.g., polyester urethanes, (meth)acrylic urethanes, as known to a person skilled in the art.

Suitable phenolic resins are, for example, phenolic resins based on bisphenol for example bisphenol A, on phenol novolacs or on cresol novolacs.

Suitable silicone resins are, for example, functionalized polysiloxanes based on mono-, di-, or tri-organo-substituted halosilanes, for example dichloromethylphenylsilane; suitable fluorocarbon resins are, for example, functionalized polymers based on fluoroethylenes and vinyl ethers, as known to a person skilled in the art.

The term (meth)acrylate is respectively intended to mean acrylic and/or methacrylic.

Preferably epoxy resins based on reaction products prepared from epichlorohydrin with bisphenol based resins, with phenolic resins based on bisphenol, with phenolic novolacs, with cresol novolacs, and/or epoxy (meth)acrylic resins are used as component A).

Preferred resins have a glass transition temperature (Tg) in the range of 40 to 100° C., preferably 45 to 65° C., an average molecular weight from 1000 to 50,000 determined from gel permeation chromatography (GPC) using polystyrene standard.

Crystalline and/or semicrystalline resins are also usable which have a Tm (melting temperature) in the range of, e.g., 50 to 120° C.

The resins of component A) can also be at least one self crosslinkable resin containing cross-linkable functional groups.

The cross-linking agents, component B), include conventional curing agents, known at a person skilled in the art and selected in dependency of selected component A). Examples are bisphenol-based phenolic resins, phenolic novolac resins, cresol novolac resings, cycloaliphatic, aliphatic or aromatic polyisocyanates; cross-linking agents containing epoxy groups, such as, for example, triglycidyl isocyanurate (TGIC); glycidyl-functionalized (meth)acrylic copolymers; crosslinking agents containing hydroxyalkylamide groups, for example N,N,N′,N′-tetra-(2-hydroxyethyl)adipamide, and cross-linking agents containing amino, amido, (meth)acrylate or hydroxyl groups, as well as vinyl ethers. Furthermore, conventionally cross-linking agents such as dicyanodiamide hardeners, and carboxylic acid hardeners or phenolic hardeners are usable.

The powder coating composition of this invention contains 0.1 to 10 wt %, preferably 0.2 to 5 wt % of at least one opacifying agent C). These agents C) comprise all opacifying agents which may be incorporated into the polymeric binder system to prepare the powder coating composition according to the invention. These opacifying agents are generally of two types, dyes soluble in the polymeric binder system, and pigments insoluble in the polymeric binder system.

Either insoluble pigment particles with particle sizes smaller than 2 μm, or soluble dyes are preferred as component C). Particularly preferred are insoluble pigment particles with particle sizes of 1 μm or smaller than 1 μm, for example, between 30 nm and 1000 nm, and soluble dyes.

The particle size as named in this description is determined by the standard method of ASTM D1366-86(2007).

The term “opacity” is described in terms of the contrast ratio (CR) at a specified coating thickness, and is measured by comparing the difference in color (Y) of a coating over black and white substrates:

$$CR = 100 \% \times \frac{Y ( over black substrate )}{Y ( over white substrate )}$$

see appendix C, page 392 of “Powder Coating, The Complete Finishers Handbook”, second edition, 1999, Nicholas Iiberto, ed. published by the Powder Coating Institute (www.powdercoating.org).

To be considered opaqe for most applications, a coating should provide a CR of 95% or above, in general. According to this invention opacifying agents are preferred in the coating composition of this invention providing a CR between 30 and 98%, preferably a CR of 70% to 98%, of the resulted coating.

Examples of suitable opacifying agents are black pigments such as those produced by furnace, gas, or lamp processes, the processes known at a skilled person, as well as polymer soluble dyes of dye classes selected from the group of methines, perinones, anthraquinones, monoazos, heterocyclics, azomethines, azometal complexes, naphtalimides, thioxanthene benzanthrones, thioindios. Preferred is the use of furnace produced black pigments and/or soluble dyes of dye classes selected from the group of methines, perinones, anthraquinones, azomethines and azometal complexes, and mixtures therefrom.

The powder coating composition may contain transparent, color-imparting and/or special effect-imparting pigments and/or extenders (fillers) as component D). Suitable color-imparting pigments are any conventional coating pigments of an organic or inorganic nature. Examples of inorganic or organic color-imparting pigments are titanium dioxide, micronized titanium dioxide, carbon black, azopigments, and phthalocyanine pigments. Examples of special effect-imparting pigments are metal pigments, for example, made from aluminum, copper or other metals, interference pigments, such as, metal oxide coated metal pigments and coated mica. Examples of usable extenders are silicon dioxide, aluminum silicate, barium sulfate, and calcium carbonate.

Additives can also be used as component D). Additives are the conventional coating additives known at a person skilled in the art. Examples are levelling agents, rheological agents such as highly dispersed silica or polymeric urea compounds, thickeners, for example based on partially cross-linked, carboxy-functional polymers or on polyurethanes, defoamers, wetting agents, anticratering agents, degassing agents, thermolabile initiators, antioxidants and light stabilizers based on HALS (hindered amine light stabilizer) products, initiators, inhibitors and catalysts, for example, imidazoles, ammonium salts, phosphonium salts, Lewis acids such as zinc, tin, or aluminum complexes. The additives can be used, in conventional amounts known to the person skilled in the art, for example, 0.01 to 10 wt. %, based on the total weight of the powder coating composition.

The powder coating composition may be prepared by conventional powder manufacturing used in the powder coating industry. For example, the ingredients used in the powder coating composition, can be blended together and heated to a temperature to melt the mixture, and then the mixture is extruded. The extruded material is then cooled on chill roles, broken up and then ground to a fine powder, which can be classified to the desired grain size, for example, to an average particle size of 20 to 200 μm.

The powder coating composition may also be prepared by spraying from supercritical solutions, NAD “non-aqueous dispersion” processes or ultrasonic standing wave atomization process.

Furthermore, specific components of the composition according to the invention, for example, at least one opacifying agent, additive, pigment and/or extender, may be processed with the finished powder coating particles, resulted from powder manufacturing of components A), B) and D), by a “bonding” process using an impact fusion. For this purpose, the specific components may be mixed with the finished powder coating particles based on components A), B) and D). During blending, the individual powder coating particles are treated to softening their surface so that the components adhere to them and are homogeneously bonded with the surface of the powder coating particles. The softening of the powder particles' surface may be done by heat treating the particles to a temperature, e.g., the glass transition temperature Tg of the composition, in a range of, e.g., 50 to 60° C. After cooling the mixture the desired particle size of the resulted particles may be proceed by a sieving process. Preferred is the bonding of at least one opacifying agent with the the finished powder coating particles, based on components A), B) and D).

The powder coating composition of this invention may be applied by electrostatic spraying, thermal or flame spraying, or fluidized bed coating methods, all of which are known to those skilled in the art.

The coatings may be applied to non-metallic substrates as primer coat, but, particularly to metallic substrates, onto pre-heated or non-pre-heated substrates.

In certain applications, the substrate to be coated may be pre-heated before the application of the powder, and then either heated after the application of the powder or not. For example, gas is commonly used for various heating steps, but other methods, e.g., microwaves, IR or NIR are also known.

The curing of the powder coating composition is possible by UV irradiation known to a skilled person, and/or by thermal curing, e.g., by gas heating, IR or NIR as known in the art. Dual curing is also usable, and means a curing method of the powder coating composition according to the invention where the applied composition can be cured both by UV irradiation and by thermal curing methods known to a skilled person.

The present invention is further defined in the following Examples. It should be understood that these Examples are given by way of illustration only. As a result, the present invention is not limited by the illustrative examples set forth herein below, but rather is defined by the claims contained herein below.

### EXAMPLES

### Raw Materials

The following raw materials were used to prepare the example powder coating compositions:

Epon Resin 2002: Bisphenol A-based epoxy resin from Hexion Specialty Chemicals, Inc., Houston, Tex.

Almatex® PD7690: Glycidyl methacrylate (GMA) co-polymer resin from Anderson Development Company, Adrian Mich.

Casamine OTB: Ortho-tolyl biguanide curing agent from Thomas Swan & Co. Ltd., Crookhall, County Durham, England

Dodecanedioic Acid: curing agent from E.I. DuPont de Nemours, Wilmington, Del.

Powdermate® 570FL: flow and leveling additive from Troy Chemical Corporation, Newark, N.J.

Oxymelt® A4: degassing additive from Estron Chemical Company, Calvert City, Ky.

Benzoin: degassing additive from GCA Chemical Corporation, Bradenton, Fla.

Raven 5000: carbon black pigment from Columbian Chemicals Company, Marietta, Ga.

Thermoplast Black X 70: dye from BASF Corporation, Ludwigshafen, Germany

### Bisphenol A Epoxy Based Powder Compositions

Powder coating compositions were prepared using the formulations listed in Table 1.

TABLE 1
Formulations for bisphenol A epoxy resin based powder coating
compositions (in weight percent)

| | Example | | |
|---|---|---|---|
| | 1 | 2 | 3 |
| Epon Resin 2002 | 93.28 | 91.42 | 92.77 |
| Casamine OTB | 4.20 | 4.11 | 4.17 |
| Powdermate ® 570 FL | 1.87 | 1.83 | 1.86 |
| Benzoin | 0.65 | 0.64 | 0.65 |
| Thermoplast Black X 70 | — | 2.00 | — |
| Raven 5000 (furnace | — | — | 0.55 |
| produced) | | | |
| TOTAL | 100.00 | 100.00 | 100.00 |

### Example 1

### This Example is Outside the Scope of the Invention, and is Presented for Comparative Purposes (Prior Art Comparison)

A 3000 gram batch of composition 1 was combined in a plastic bag and mixed for two minutes. The mixture was extruded by passing three times through a known 30 mm powder coating extruder with an 8:1 length/diameter ratio. The extrudate was cooled, solidified and pressed into a thin sheet by passing between two chilled rollers. The friable room-temperature thin sheet was ground to a powder through a hammer mill, then sieved through a 150 μm screen to remove large particles. The powdered coating material was applied to a 4×12×0.12 inch steel panel to a thickness of 7 mils (175 μm) by pre-heating the panel to 400 F, (204° C.), spraying the coating onto the panel by electrostatic spray, baking the coated panel in an oven for 10 minutes at 350 F (177° C.), then cooling to room temperature. The clear, transparent coating was smooth, glossy, and free of orange peel.

### Example 2

### This Example is Within the Scope of the Invention Receiving a Black Coating

The manufacture and application procedure was the same as described in Example 1, with the exception that the powdered coating material was applied to a thickness of 6 mils (150 μm).

### Example 3

### This Example is Within the Scope of the Invention Receiving a Black Coating

The manufacture and application procedure was the same as described in Example 1, with the exception that the powdered coating material was applied to a thickness of 5 mils (125 μm).

### GMA Acrylic Based Primers

Powder coating compositions were prepared using the formulations listed in Table 2.

TABLE 2
Formulations for GMA acrylic resin based powder coating
compositions (in weight percent).

| | Example | | |
|---|---|---|---|
| | 4 | 5 | 6 |
| Almatex ® PD7690 | 80.32 | 78.72 | 79.92 |
| Dodecanedioic Acid | 17.27 | 16.92 | 17.18 |
| Oxymelt ® A4 | 1.20 | 1.18 | 1.20 |
| Powdermate ® 570 FL | 1.20 | 1.18 | 1.20 |
| Thermoplast Black | — | 2.00 | — |
| Raven 5000 | — | — | 0.50 |
| TOTAL | 100.00 | 100.00 | 100.00 |

### Example 4

### This Example is Outside the Scope of the Invention, and is Presented for Comparative Purposes (Prior Art Comparison) Receiving a Clear Coating

The manufacture and application procedure was the same as described in Example 1, with the exception that the powdered coating material was applied to a thickness of 5 mils (125 μm).

### Example 5

### This Example is Within the Scope of the Invention Receiving a Black Coating

The manufacture and application procedure was the same as described in Example 1, with the exception that the powdered coating material was applied to a thickness of 5 mils (125 μm).

### Example 6

### This Example is Within the Scope of the Invention Receiving a Black Coating

The manufacture and application procedure was the same as described in Example 1, with the exception that the powdered coating material was applied to a thickness of 5 mils (125 μm).

### Test Results

The received cured films were measured by careful visual smoothness determination and by optical DOI smoothness measurement (using a BYK-Gardner wavescan-DOI meter). DOI (distinctness of image) is measured on a scale of 0 to 100 according to ASTM standard D 5657-95, reapproved 1999. The results are shown in Table 3.

TABLE 3

| | | Opacifying | Visual | |
|---|---|---|---|---|
| Example | Purpose | Agent C) | Smoothness | DOI |
| 1 | Prior Art Comparison | None | Very Smooth | 75.6 |
| 2 | Illustrates Invention | Dye | Very Smooth | 96.2 |
| 3 | Illustrates Invention | Pigment | Very Smooth | 96.8 |
| 4 | Prior Art Comparison | None | Very Smooth | 71.0 |
| 5 | Illustrates Invention | Dye | Very Smooth | 96.3 |
| 6 | Illustrates Invention | Pigment | Very Smooth | 96.1 |

Comparison of these films shows that optical smoothness evaluations by optical DOI smoothness measurement were much more easily made on the opaque substrates provided by Examples 2, 3, 5 and 6 than on the transparent substrates provided by comparative Examples 1 and 4, and demonstrates improved smoothness measurement accuracy by optical DOI smoothness measurement. Examples 2, 3, 5 and 6 according to the invention show an excellent smoothness measured by DOI smoothness measurement.

What is claimed is:

1. A powder coating composition comprising an intimate mixture comprising
A) 50 to 99 wt % of at least one resin binder selected from the group consisting of polyester resins, epoxy resins, urethane resins, (meth)acrylic resins, silicone resins, fluorocarbon resins, phenolic resins,
B) 0 to 95 wt % of at least one cross-linking agent,
C) 0.1 to 10 wt % of at least one opacifying agent, and
D) 0.01 to 20 wt % of at least one coating additive, pigment and/or extender (filler),
wherein the wt % are based on the total weight of the powder coating composition.

2. The composition of claim 1 wherein component A) is in a range of 70 to 95 wt %.

3. The composition of claim 1 wherein component B) is in a range of 1 to 50 wt %.

4. The composition of claim 1 wherein component C) is in a range of 0.2 to 5 wt %.

5. The composition of claim 1 wherein the epoxy resins are selected from the group consisting of reaction products prepared from epichlorohydrin with bisphenol based resins, reaction products prepared from epichlorohydrin with phenolic resins based on bisphenol, reaction products prepared from epichlorohydrin with phenolic novolacs, reaction products prepared from epichlorohydrin with cresol novolacs, and epoxy (meth)acrylic resins are used as component A).

6. The composition of claim 1 wherein insoluble pigment particles with particle sizes between 30 nm and 1000 nm are used as component C),

7. The composition of claim 1 wherein opacifying agents providing a contrast ratio (CR) between 30 and 98% of the resulted coating are used, the CR measured by comparing the difference in color (Y) of a coating over black and white substrates.

8. A process of preparation a powder coating composition of claim 1 using the bonding process comprising the steps
a) mixing of at least one opacifying agent of component C) with the finished powder coating particles resulted from powder manufacturing of components A), B) and D),
b) heating the mixture to a temperature of 50 to 60° C. during mixing,
c) cooling the mixture and sieving to the desired particle size.

9. A coating process comprising the steps (a1) applying the composition according to claim 1 onto a substrate, and (b1) curing the applied composition.

10. A substrate coated with the cured composition of claim 1.
